(19) United States
(12) Patent Application Publication
(10) Pub. No.: US 2023/0150362 A1
(43) Pub. Date: May 18, 2023

(54) VEHICLE DISPLAY DEVICE, VEHICLE, VEHICLE DISPLAY SYSTEM, VEHICLE DISPLAY METHOD, AND NON-TRANSITORY COMPUTER-READABLE MEDIUM

(71) Applicant: TOYOTA JIDOSHA KABUSHIKI KAISHA, Toyota-shi (JP)

(72) Inventors: Fumihiro KONNO, Suntou-gun (JP); Takahiro KATO, Toyota-shi (JP)

(73) Assignee: TOYOTA JIDOSHA KABUSHIKI KAISHA, Toyota-shi (JP)

(21) Appl. No.: 17/949,858

(22) Filed: Sep. 21, 2022

(30) Foreign Application Priority Data
Nov. 12, 2021 (JP) 2021-185025

(51) Int. Cl. B60K 35/00; B60W 50/14

(52) U.S. Cl. CPC B60K 35/00; B60W 50/14; B60K 2370/166; B60K 2370/178; B60K 2370/1868; B60K 2370/589; B60W 2050/146; B60W 2556/50

(57) ABSTRACT

A vehicle display device including: a memory; a display installed at a vehicle; and a processor coupled to the memory and controlling the display, the processor is configured to: when a specific event occurs, set the display to a state of being able to display a hazard map image showing a hazard map of a predetermined geographical region.

### CROSS-REFERENCE TO RELATED APPLICATION

This application claims priority under 35 USC 119 from Japanese Patent Application No. 2021-185025, filed on Nov. 12, 2021, the disclosure of which is incorporated by reference herein.

### BACKGROUND

### Technical Field

The present disclosure relates to a vehicle display device, a vehicle, a vehicle display system, a vehicle display method and a non-transitory computer-readable medium storing a program.

### Related Art

Japanese Patent Application Laid-Open (JP-A) No. 2019-049443 discloses an invention that displays a hazard map image in a manner of being superposed on the map image of a navigation system, which map image is displayed on a display of the vehicle.

The display can be controlled so as to always display the hazard map image in a superposed manner on the map image. However, in such a case, it is easy for the vehicle occupant who is viewing the display to be annoyed thereby.

### SUMMARY

The present disclosure provides a vehicle display device, a vehicle, a vehicle display system, a vehicle display method and a (on-transitory) computer-readable medium storing a program, which may display a hazard map image such that it is difficult for the vehicle occupant who is viewing the display to be annoyed thereby.

A first aspect of the present disclosure is a vehicle display device including: a memory; a display installed at a vehicle; and a processor coupled to the memory and controlling the display, the processor is configured to: when a specific event occurs, set the display in to a state of being able to display a hazard map image showing a hazard map of a predetermined geographical region.

When a specific event occurs, the processor of the vehicle display device of the first aspect of the present disclosure sets the display in a state of being able to display the hazard map image that shows a hazard map of a predetermined geographical region. If a hazard map image were to be displayed on the display frequently regardless of the occurrence of a specific event, it would be easy for the vehicle occupant who is viewing the display to become annoyed. In contrast, in the vehicle display device of the first aspect, the display is set in a state of being able to display the hazard map image, which shows a hazard map of a predetermined geographical region, when a specific event occurs. Therefore, it is difficult for the vehicle occupant who is viewing the display to become annoyed.

A second aspect of the present disclosure, in the above-described first aspect, may further include a receiver that receives information relating to the hazard map image by wireless communication from an external communication device.

In the second aspect of the present disclosure, the vehicle has a receiver that may receive information relating to the hazard map image by wireless communication from an external communication device. Therefore, there is no need for the vehicle to be equipped with a recording device that records information relating to the hazard map.

In a third aspect of the present disclosure, in the above-described first or second aspect, the hazard map image may be a hazard map image of a geographical region that includes a current position of the vehicle.

In the third aspect of the present disclosure, the hazard map image is a hazard map image of a geographical region that includes the current position of the vehicle. If the hazard map image of the geographical region that includes the current position of the vehicle is displayed on the display regardless of the intent of the vehicle occupant, it is difficult for the vehicle occupant who is viewing the display to become annoyed, as compared with a case in which a hazard map image of a geographical region that does not include the current position of the vehicle is displayed on the display regardless of the intent of the vehicle occupant.

A fourth aspect of the present disclosure, in the vehicle display device of the above-described first or second aspect, may include: a navigation system that sets a traveling route to a destination, wherein the display may display a map image that includes the destination and the traveling route, and the specific event occurs when the vehicle arrives at the destination.

In the fourth aspect of the present disclosure, the specific event occurs when the vehicle arrives at the destination on the traveling route that is set by the navigation system. If the hazard map image is displayed on the display when the vehicle arrives at the destination, the possibility that the vehicle occupant who is viewing the display will be annoyed is low, as compared with a case in which the hazard map is displayed on the display while the vehicle is traveling.

In a fifth aspect of the present disclosure, in the above-described first or second aspect, the processor may be configured to, in a case in which a select operation, which selects at least one displayed region from among a plurality of geographical regions, is executed with respect to a first operation device provided at the vehicle, cause the display to display the hazard map image relating to the displayed region.

In the fifth aspect of the present disclosure, when a select operation is executed with respect to a first operation device provided at the vehicle, the hazard map image relating to the displayed region, which is the geographical region selected from among plural geographical regions, is displayed on the display. In this way, in a case in which the hazard map image that relates to the displayed region, which the vehicle occupant selected by their own intent, is displayed on the display, it is difficult for the vehicle occupant who is viewing the display to become annoyed, as compared with a case in which a hazard map image relating to a geographical region that is selected regardless of the intent of the vehicle occupant is displayed on the display.

In a sixth aspect of the present disclosure, in the above-described aspects, the processor may be configured to: when the specific event occurs, may cause a notification device to give notice of information urging a vehicle occupant of the vehicle to execute a display operation with respect to a second operation device provided at the vehicle, and in response to execution of the display operation with respect to the second operation device, may cause the display to display the hazard map image.

In the sixth aspect of the present disclosure, when the specific event occurs, the notification device gives notice of information urging a vehicle occupant to execute a display operation with respect to a second operation device provided at the vehicle. When the vehicle occupant executes the display operation with respect to the second operation device, the hazard map image is displayed on the display. In this way, in a case in which the hazard map image is displayed on the display when the vehicle occupant executes a display operation by their own intent, it is difficult for the vehicle occupant who is viewing the display to become annoyed, as compared with a case in which a hazard map image is displayed on the display regardless of the intent of the vehicle occupant.

In a seventh aspect of the present disclosure, in the above-described aspects, the specific event may occur when a predetermined day arrives.

In the seventh aspect of the present disclosure, the specific event occurs when a predetermined day arrives. If a hazard map image is displayed on the display on a predetermined day, there is a low possibility that the vehicle occupant who is viewing the display will be annoyed.

An eighth aspect of the present disclosure is a vehicle that includes the vehicle display device of any of the above-described aspects.

A ninth aspect of the present disclosure is a vehicle display system including: the vehicle of the above-described eighth aspect; and an external communication device that can wirelessly transmit information relating to the hazard map image to a receiver provided at the vehicle.

A tenth aspect of the present disclosure is a processor is configured to, when a specific event occurs, set a display installed in a vehicle in a state of being able to display a hazard map image showing a hazard map of a predetermined geographical region.

An eleventh aspect of the present disclosure is a non-transitory computer-readable medium on which is recorded a program that causes a processor to execute processing of, when a specific event occurs, setting a display installed in a vehicle in a state of being able to display a hazard map image showing a hazard map of a predetermined geographical region.

In accordance with the above-described aspects, the vehicle display device, vehicle, vehicle display system, vehicle display method and non-transitory computer-readable medium storing a program relating to the present disclosure may display a hazard map image such that it is difficult for the vehicle occupant who is viewing the display to be annoyed thereby.

### BRIEF DESCRIPTION OF THE DRAWINGS

Exemplary embodiments will be described in detail based on the following figures, wherein:

FIG. 1 is a drawing illustrating a vehicle display system that includes a vehicle that has a vehicle display device relating to an exemplary embodiment;

FIG. 2 is a control block drawing of an ECU of the vehicle illustrated in FIG. 1 and an external server;

FIG. 3 is a functional block drawing of the ECU illustrated in FIG. 2;

FIG. 4 is a functional block drawing of the external server illustrated in FIG. 1;

FIG. 5 is a drawing illustrating a specific event judgment map that is recorded in a ROM or a storage of the external server;

FIG. 6 is a drawing illustrating a main image of a display provided at the vehicle illustrated in FIG. 1;

FIG. 7 is a drawing illustrating when a notification image is displayed so as to be superposed on the main image;

FIG. 8 is a drawing illustrating when a notification image is displayed so as to be superposed on an initial screen of a music application;

FIG. 9 is a drawing illustrating when a notification image is displayed so as to be superposed on a map image;

FIG. 10 is a flowchart illustrating processing executed by the external server;

FIG. 11 is a flowchart illustrating processing executed by the ECU;

FIG. 12 is a drawing illustrating when map select button images are displayed so as to be superposed on the map image; and

FIG. 13 is a drawing illustrating when a hazard map image is displayed so as to be superposed on the map image.

### DETAILED DESCRIPTION

A vehicle display device, vehicle, vehicle display system, vehicle display method and program relating to the present disclosure are described hereinafter with reference to the drawings.

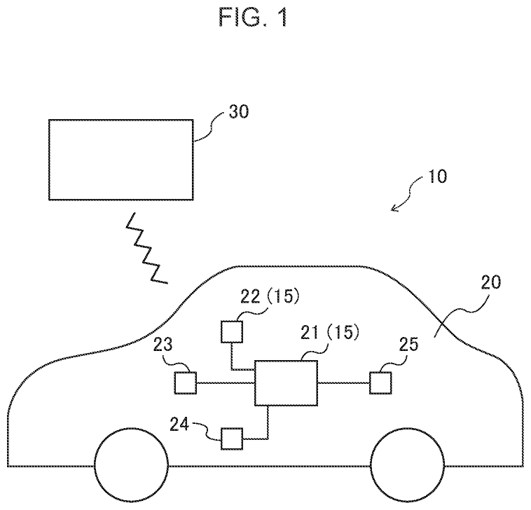

As illustrated in FIG. 1, a vehicle display system 10 of the present exemplary embodiment has a vehicle 20 and an external server (external communication device) 30.

As illustrated in FIG. 1, the vehicle 20, which can communicate data with the external server 30 via a network (e.g., the internet), has an ECU (Electronic Control Unit) 21, a display (first operation device, second operation device) (notification device) 22 having a touch panel, a speaker (notification device) 23, an IG-SW (ignition switch) 24, and a GPS (Global Positioning System) receiver 25. A vehicle ID is given to the vehicle 20. The display 22, the speaker 23, the IG-SW 24 and the GPS receiver 25 are connected to the ECU 21. The ECU 21 and the display 22 are structural elements of a vehicle display device 15.

As will be described later, the display 22 can display various images. The speaker 23 can output various sounds. The GPS receiver 25 acquires information relating to the position at which the vehicle 20 is traveling (hereinafter called “position information”) by receiving GPS signals transmitted from GPS satellites. When the IG-SW 24 is off, the drive source of the vehicle 20 is inoperable, and, when the IG-SW 24 is on, the drive source can operate. Note that, for example, at least one of an engine and an electric motor is included as the drive source. Therefore, the “IG-SW” of the present specification includes an ignition switch that is operated by a key, as well as other switches. For example, a push-type start button is included as such another switch.

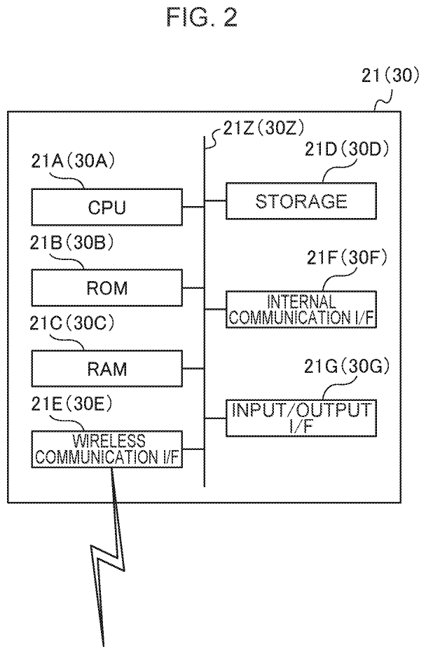

As illustrated in FIG. 2, the ECU 21 is configured to include a CPU (Central Processing Unit) (processor) 21A, a ROM (Read Only Memory) 21B, a RAM (Random Access Memory) 21C, a storage 21D, a wireless communication I/F (interface) (receiver) 21E, an internal communication I/F 21F, and an input/output I/F 21G. The CPU 21A, the ROM 21B, the RAM 21C, the storage 21D, the wireless communication I/F 21E, the internal communication I/F 21F and the input/output I/F 21G are connected so as to be able to communicate with one another via internal bus 21Z. The ECU 21 can acquire information relating to the time from a timer. The display 22, the speaker 23, the IG-SW 24 and the GPS receiver 25 are connected to the ECU 21 (the input/output I/F 21G).

The CPU 21A is a central computing processing unit, and executes various programs and controls the respective sections. The CPU 21A reads-out programs from the ROM 21B or the storage 21D, and executes the programs by using the RAM 21C as a workspace. The CPU 21A controls the respective structures and carries out various computing processings in accordance with the programs recorded in the ROM 21B or the storage 21D.

The ROM 21B stores various programs and various data. The RAM 21C temporarily stores programs and data as a workspace. The storage 21D is configured by a storage device such as an HDD (Hard Disk Drive) or an SSD (Solid State Drive) or the like, and stores various programs and various data. For example, map data of the entire country in which the vehicle 20 is located is recorded in the storage 21D.

The wireless communication I/F 21E is an interface for communicating wirelessly with various equipment. For example, the wireless communication I/F 21E can communicate wirelessly with the external server 30. Communication standards such as Bluetooth, Wi-Fi, or the like are used at the wireless communication I/F 21E.

The internal communication I/F 21F is an interface for connection, via an external bus, with ECUs other than the ECU 21 that is provided at the vehicle 20.

The input/output I/F 21G is an interface for communicating with the display 22, the speaker 23, the IG-SW 24, and the GPS receiver 25.

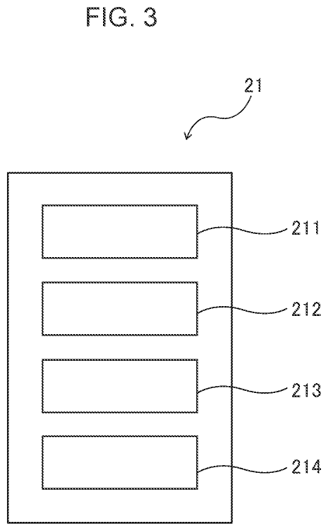

An example of functional structures of the ECU 21 is illustrated in a block drawing in FIG. 3. The ECU 21 has, as the functional structures thereof, a display control section 211, a speaker control section 212, an operation determining section 213, and a transmitting/receiving control section 214. The display control section 211, the speaker control section 212, the operation determining section 213 and the transmitting/receiving control section 214 are realized by the CPU 21A reading-out a program that is stored in the ROM 21B and executing the program.

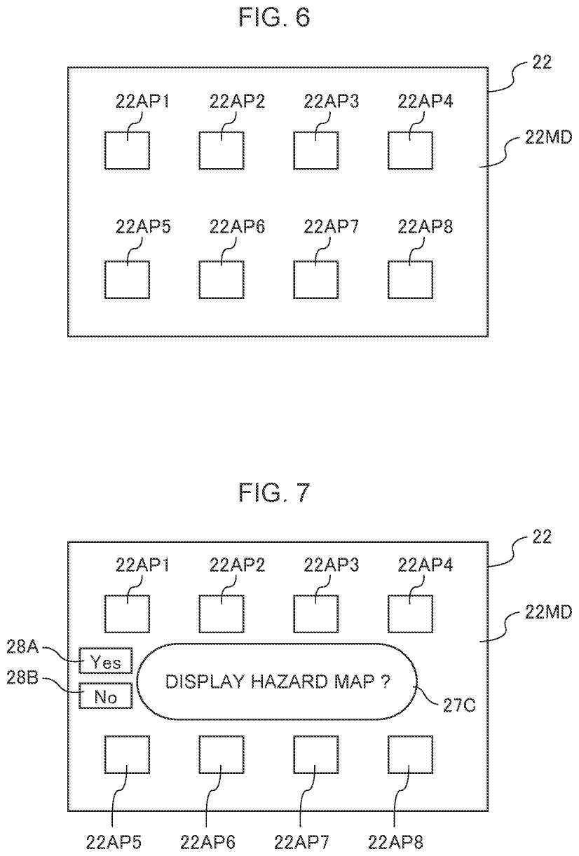

The display control section 211 controls the display 22. Plural applications (programs) are installed in the ECU 21. Therefore, as illustrated in FIG. 6, when the display 22 is in an on state, the display control section 211 can display a main image (initial image) 22MD that includes application images (hereinafter called APP images) 22AP1, 22AP2, 22AP3, 22AP8 that represent eight applications. The APP image 22AP1 is an image representing a navigation application. Namely, a navigation system is installed in the vehicle 20. The APP image 22AP2 is an image representing a music application. Moreover, as will be described later, the display control section 211 displays various images including a map image and a hazard map image on the display 22.

The speaker control section 212 controls the speaker 23.

The operation determining section 213 carries out various processings relating to touch operations carried out by the finger of a vehicle occupant with respect to various operation images displayed on the display 22 (the touch panel), as will be described later.

The transmitting/receiving control section 214 controls the wireless communication I/F 21E and the internal communication I/F 21F. As will be described later, the transmitting/receiving control section 214 wirelessly transmits various information to the external server 30 via the wireless communication I/F 21E, and causes the wireless communication I/F 21E to receive various information that are wirelessly transmitted from the external server 30.

As illustrated in FIG. 2, the external server 30 illustrated in FIG. 1 is configured to include, as the hardware structures thereof, a CPU (processor) 30A, a ROM 30B, a RAM 30C, a storage 30D, a wireless communication I/F 30E, an internal communication I/F 30F and an input/output I/F 30G. The CPU 30A, the ROM 30B, the RAM 30C, the storage 30D, the wireless communication I/F 30E, the internal communication I/F 30F and the input/output I/F 30G are connected so as to be able to communicate with one another via an internal bus 30Z. The external server 30 can acquire information relating to the time from a timer.

Data relating to a hazard map of the entire country in which the vehicle 20 is located is recorded in the ROM 30B or the storage 30D of to the external server 30. When a new disaster occurs in the country in which the vehicle 20 is located, the contents of the data relating to the hazard map are updated as needed. Note that disasters, which are prescribed by the hazard map of the present exemplary embodiment and by a specific event judgment map 35 that is described later include, for example, earthquakes, landslides, floods and tsunamis.

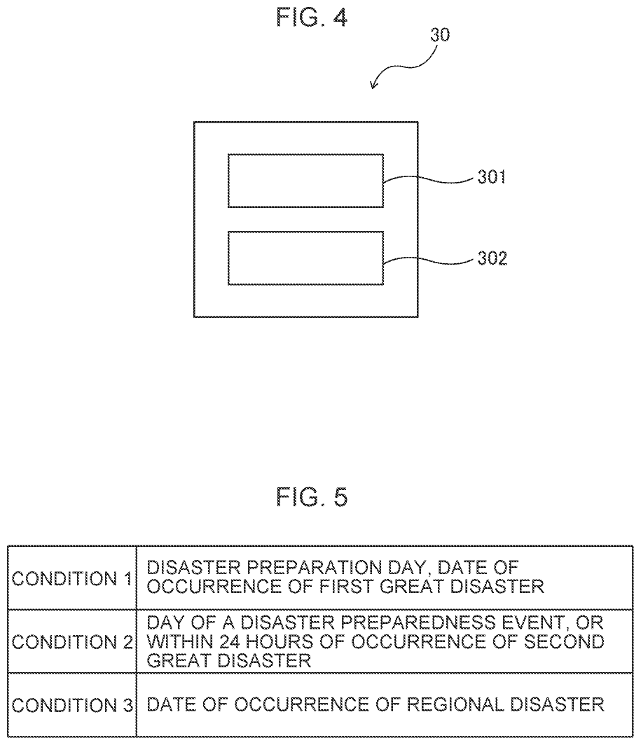

An example of the functional structures of the hardware of the external server 30 are illustrated in a block drawing in FIG. 4. The hardware of the external server 30 has a condition determining section 301 and a transmitting/receiving control section 302 as the functional structures. The condition determining section 301 and the transmitting/receiving control section 302 are realized by the CPU 30A reading-out a program that is stored in the ROM 30B and executing the program.

As will be described later, the condition determining section 301 determines whether or not various conditions have been satisfied. For example, the condition determining section 301 determines whether or not at least one of conditions 1 to 3, which are prescribed by the specific event judgment map 35 (see FIG. 5) that is recorded in the ROM 30B, is satisfied. Note that, when the condition determining section 301 determines that at least one of conditions 1 to 3 is satisfied, the condition determining section 301 determines that a specific event has occurred.

Condition 1 is established in a case in which the current date that is recognized by the condition determining section 301 on the basis of the aforementioned timer is Disaster Prevention Day (September 1) established by the Japanese government, or is a date that is one year after or plural years after the date of the occurrence of a first category of great disaster. A first category of great disaster is a disaster in which particularly great damage has been inflicted on any geographical region, among the disasters that have occurred in the country in which the vehicle 20 is located.

Condition 2 is established in a case in which the current date that is recognized by the condition determining section 301 on the basis of the aforementioned timer is the day of a disaster preparedness event held by a local government of the geographical region in which the vehicle 20 is located, or in a case in which the current time is within 24 hours from the time of occurrence of a second category of great disaster that has occurred in the country in which the vehicle 20 is located. A second category of great disaster is a disaster that is different from a first category of great disaster and in which great damage has been inflicted on any geographical region, among the disasters that have occurred in the country in which the vehicle 20 is located.

Condition 3 is established in a case in which the current date that is recognized by the condition determining section 301 on the basis of the aforementioned timer is a date that is one year after or plural years after the date of the occurrence of a specific geographical regional disaster. A specific geographical region disaster is a disaster that, among the disasters that have occurred in the geographical region in which the vehicle 20 is located, inflicted great damage on that geographical region.

When a new disaster occurs in the country in which the vehicle 20 is located, the contents of the specific event judgment map 35 are updated as needed.

The transmitting/receiving control section 302 controls the wireless communication I/F 30E and the internal communication I/F 30F. As will be described later, the transmitting/receiving control section 302 wirelessly transmits various information to the vehicle 20 via the wireless communication I/F 30E, and causes the wireless communication I/F 30E to receive various information that are wirelessly transmitted from the vehicle 20.

Operation of the present exemplary embodiment are described next.

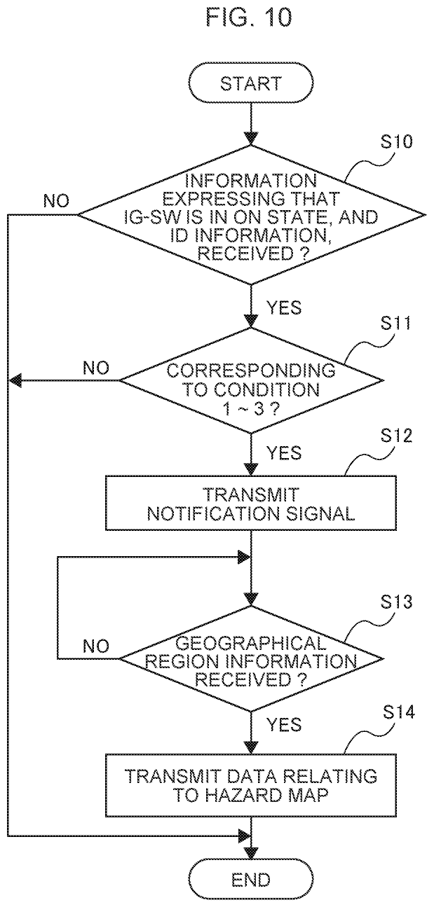

First, the flow of the processing that the external server 30 carries out is described by using the flowchart of FIG. 10. The external server 30 repeatedly executes the processing of the flowchart of FIG. 10 each time a predetermined time period elapses.

First, in step S10, the condition determining section 301 of the external server 30 determines whether or not information expressing that the IG-SW 24 is in an on state, and ID information of the vehicle 20, have been received from the vehicle 20.

The external server 30 that has made an affirmative determination in step S10 moves on to step S11, and the condition determining section 301 determines whether or not at least one of conditions 1 to 3 are established.

The external server 30 that has made an affirmative determination in step S11 moves on to step S12, and the wireless communication I/F 30E, which is controlled by the transmitting/receiving control section 302, wirelessly transmits a notification signal together with the ID information of the vehicle 20 to the vehicle 20.

The external server 30 that has finished the processing of step S12 moves on to step S13, and determines whether or not geographical region information that is described later has been received from the vehicle 20.

The external server 30 that has made an affirmative determination in step S13 moves on to step S14, and the wireless communication I/F 30E, which is controlled by the transmitting/receiving control section 302, wirelessly transmits, to the vehicle 20, data relating to the hazard map of the geographical region corresponding to the geographical region information for which an affirmative judgment was made in step S13.

When the processing of step S14 is ended, or when the judgment is negative in step S10 or step S11, the external server 30 ends the processing of the flowchart of FIG. 10 for the time being.

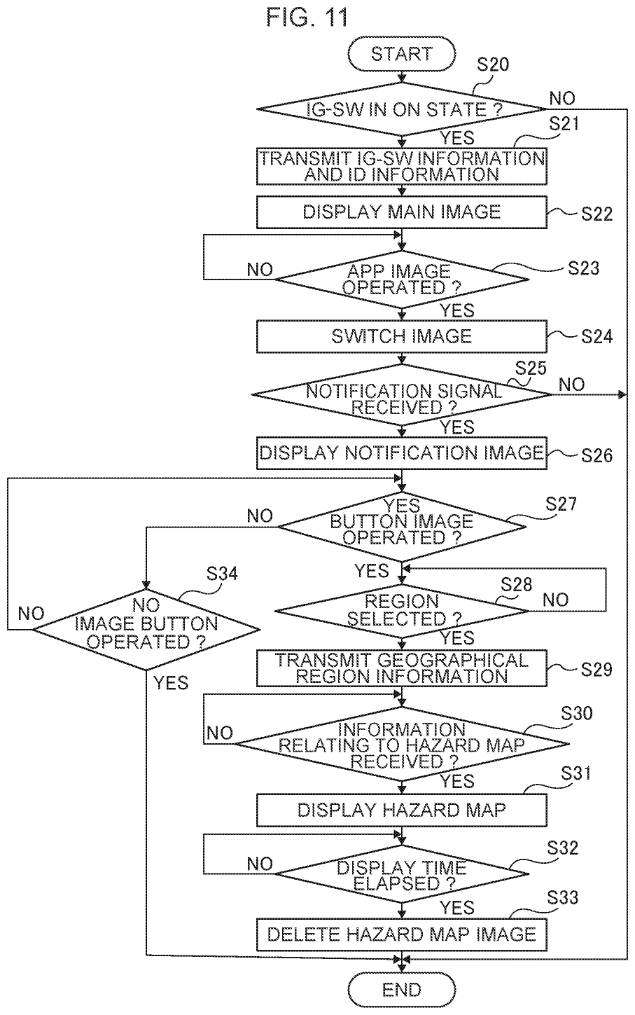

The flow of the processing that the ECU 21 carries out is described next by using the flowchart of FIG. 11. The ECU 21 repeatedly executes the processing of the flowchart of FIG. 11 each time a predetermined time period elapses.

First, in step S20, the transmitting/receiving control section 214 of the ECU 21 determines whether or not the IG-SW 24 is in an on state.

The ECU 21 that has made an affirmative determination in step S20 moves on to step S21, and the wireless communication I/F 21E, which is controlled by the transmitting/receiving control section 214, wirelessly transmits information, which expresses that the IG-SW 24 is in an on state, and the ID information of the vehicle 20 to the external server 30.

The ECU 21 that has finished the processing of step S21 moves on to step S22, and the display control section 211 displays the main image 22MD illustrated in FIG. 6 on the display 22.

The ECU 21 that has finished the processing of step S22 moves on to step S23, and determines whether or not the APP images 22AP1, 22AP2, 22AP3, 22AP8 have been touch-operated by (the finger of) a vehicle occupant.

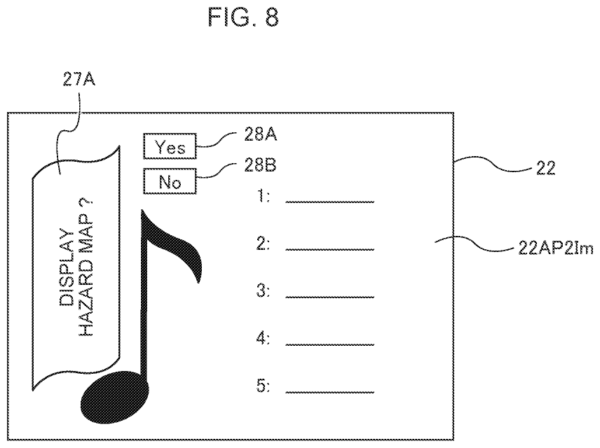

The ECU 21 that has made an affirmative determination in step S23 moves on to step S24. At this time, the application that corresponds to the APP image 22AP1, 22AP2, 22AP3, . . . , 22AP8 that was touch-operated is started by the ECU 21. For example, if a vehicle occupant touch-operates the APP image 22AP2, as illustrated in FIG. 8, the display 22 that is controlled by the display control section 211 displays initial screen 22AP2Im. Note that a notification image 27A, a Yes button image 28A and a No button image 28B are included in the initial screen 22AP2Im. However, the notification image 27A, the Yes button image 28A and the No button image 28B are not included in the initial screen 22AP2Im when the processing of step S24 is executed. When a vehicle occupant touch-operates an image included in the initial screen 22AP2Im by his/her finger, the speaker 23 that is controlled by the speaker control section 212 outputs the music selected by the touch operation.

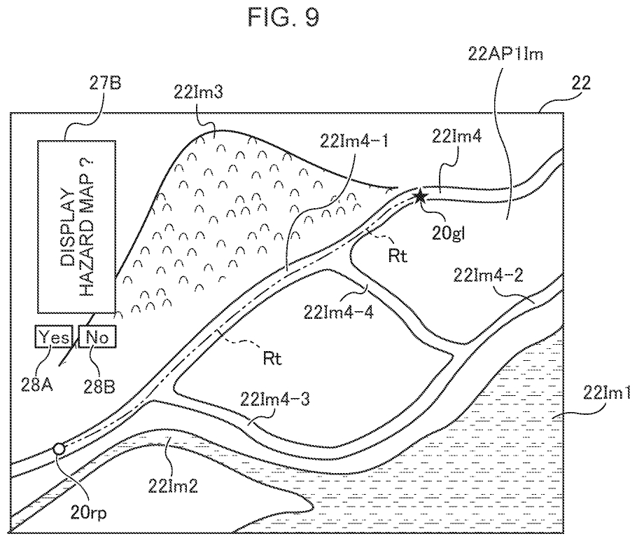

In a case in which a vehicle occupant touch-operates the AP image 22AP1 in step S23, as illustrated in FIG. 9, the display 22 that is controlled by the display control section 211 displays a map image 22AP1Im. Note that a notification image 27B, the Yes button image 28A and the No button image 28B are included in the map image 22AP1Im illustrated in FIG. 9. However, the notification image 27B, the Yes button image 28A and the No button image 28B are not included in the map image 22AP1Im when the processing of step S24 is executed. This map image 22AP1Im includes an image showing the geographical region that includes the current position of the vehicle 20 specified by the ECU 21 in accordance with the position information of the vehicle 20. The map image 22AP1Im illustrated in FIG. 9 includes, for example, image 22Im1 showing the ocean, image 221m2 showing a river, image 221m3 showing a mountain, and road images 221m4 showing roads. Moreover, the road images 221m4 include road image 221m4-1 showing a substantially rectilinear road provided near the mountain (the image 221m3), road image 221m4-2 showing a substantially rectilinear road provided along the coast, road image 221m4-3 showing a substantially rectilinear road provided along the river (the image 221m2), and road image 221m4-4 showing a road that is substantially parallel to the aforementioned road (the road image 221m4-3). Note that the circular mark denoted by reference numeral 20rp in FIG. 9 is the current position of the vehicle 20 that is based on the position information of the vehicle 20. The imaginary line denoted by reference numeral Rt is the traveling route that is set by using the navigation system. The star-shaped mark denoted by reference numeral 20gl is the destination of the vehicle 20.

The ECU 21 that has finished the processing of step S24 moves on to step S25, and the transmitting/receiving control section 214 determines whether or not the wireless communication I/F 21E has received a notification signal from the external server 30.

The ECU 21 that has made an affirmative determination in step S25 moves on to step S26, and the display control section 211 displays the notification image 27A, 27B, 27C, the Yes button image 28A and the No button image 28B on the display 22. For example, in a case in which the main image 22MD is being displayed on the display 22 at the point in time of step S25, as illustrated in FIG. 7, the notification image 27C, the Yes button image 28A and the No button image 28B are displayed so as to be superposed on the main image 22MD. An image of words stating “Display hazard map?” is included in the notification image 27C. Note that the same word image is included in the notification images 27A, 27B as well. Further, in a case in which the initial screen 22AP2Im is being displayed on the display 22 at the point in time of the processing of step S25, as illustrated in FIG. 8, the notification image 27A, the Yes button image 28A and the No button image 28B are displayed so as to be superposed on the initial screen 22AP2Im. Further, in a case in which the map image 22AP1Im is being displayed on the display 22 at the point in time of the processing of step S25, as illustrated in FIG. 9, the notification image 27B, the Yes button image 28A and the No button image 28B are displayed so as to be superposed on the map image 22AP1Im.

The ECU 21 that has finished the processing of step S26 moves on to step S27, and the operating determining section 213 determines whether or not the Yes button image 28A has been touch-operated by a vehicle occupant.

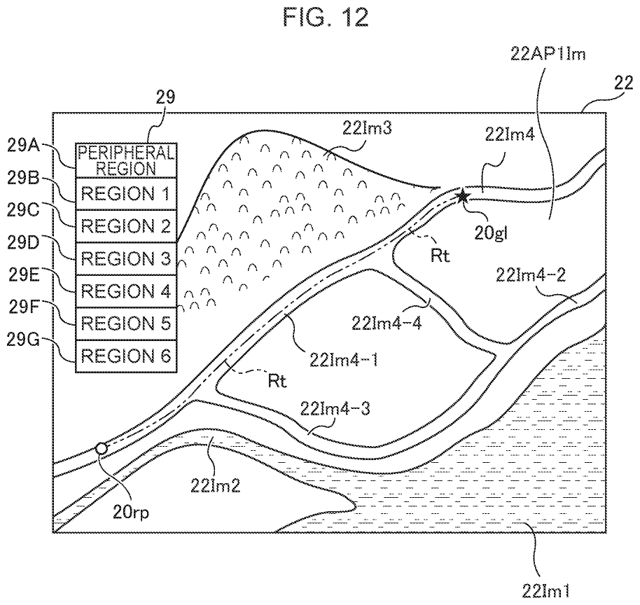

The ECU 21 that has made an affirmative determination in step S27 moves on to step S28. In this case, a region select button image 29 is displayed on the display 22. For example, in a case in which the map image 22AP1Im is being displayed on the display 22 at the point in time of the processing of step S28, as illustrated in FIG. 12, the region select button image 29 is displayed so as to be superposed on the map image 22AP1Im. A first select button image 29A, a second select button image 29B, a third select button image 29C, a fourth select button image 29D, a fifth select button image 29E, a sixth select button image 29F and a seventh select button image 29G are included in the region select button image 29. When a vehicle occupant carries out a touch-operation (display operation) with respect to any of the first select button image 29A, the second select button image 29B, the third select button image 29C, the fourth select button image 29D, the fifth select button image 29E, the sixth select button image 29F or the seventh select button image 29G, the operation determining section 213 makes an affirmative judgment in step S28. Note that, in a case in which the first select button image 29A is touch-operated, the geographical region that includes the current position of the vehicle 20 is selected as the displayed region. On the other hand, if any of the second select button image 29B, the third select button image 29C, the fourth select button image 29D, the fifth select button image 29E, the sixth select button image 29F or the seventh select button image 29G is touch-operated, a remote region that is away from the current position of the vehicle 20 is selected as the displayed region. The distances from the current position of the vehicle 20 to the respective remote regions may be any distances. For example, the distance from the current position of the vehicle 20 to the remote region corresponding to the second select button image 29B may be 100 km. The distance from the current position of the vehicle 20 to the remote region corresponding to the third select button image 29C may be 300 km.

The ECU 21 that has made an affirmative determination in step S28 moves on to step S29, and the wireless communication I/F 21E that is controlled by the transmitting/receiving control section 214 wirelessly transmits, to the external server 30, geographical region information that is information relating to the selected displayed region.

The ECU 21 that has finished the processing of step S29 moves on to step S30, and the transmitting/receiving control section 214 determines whether or not the wireless communication I/F 21E has received, from the external server 30, data relating to the hazard map of the geographical region corresponding to the geographical region information.

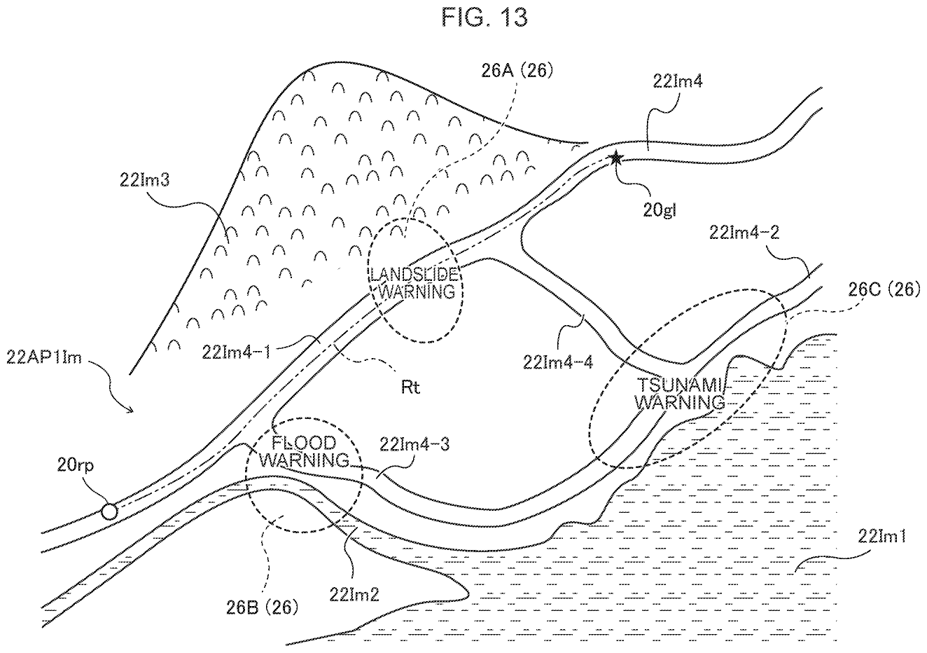

The ECU 21 that has made an affirmative determination in step S30 moves on to step S31, and, as illustrated in FIG. 13, the display 22 that is controlled by the display control section 211 displays a hazard map image 26. Here, a case in which a vehicle occupant touch-operates the first select button image 29A in step S28 is assumed. In this case, as illustrated in FIG. 13, the hazard map image 26 includes a first warning image 26A, a second warning image 26B and a third warning image 26C. The first warning image 26A shows that there have been landslides in the past in that region. The second warning image 26B shows that there has been a flood (overflowing of a river) in the past in that region. The third warning image 26C shows that there has been a tsunami in the past in that region.

Note that, for example, in a case in which a vehicle occupant touch-operates any of the second select button image 29B, the third select button image 29C, the fourth select button image 29D, the fifth select button image 29E, the sixth select button image 29F or the seventh select button image 29G in step S28, the map image of the selected remote region (displayed region) is displayed on the display 22, and the hazard map image of that remote region, which is transmitted from the external server 30, is displayed so as to be superposed on that map image.

The ECU 21 that has finished the processing of step S31 moves on to step S32 and, on the basis of information acquired from the timer, determines whether or not a predetermined display time has elapsed from the point in time when the displaying of the hazard map image 26 started. This display time is, for example, 15 minutes. However, the display time may be a length other than 15 minutes.

The ECU 21 that has made an affirmative determination in step S32 moves on to step S33, and the display control section 211 deletes the hazard map image 26 from the display 22.

The ECU 21 that has made a negative determination in step S27 moves on to step S34. When a vehicle occupant executes a touch-operation with respect to the No button image 28B, the ECU 21 makes an affirmative determination in step S34. In this case, the region select button image 29 is not displayed on the display 22. Namely, in this case, the hazard map image 26 is not displayed on the display 22.

If the determination in step S20 or S25 is negative, or if the determination in step S34 is affirmative, or when the processing of step S33 ends, the ECU 21 ends the processing of the flowchart of FIG. 12 for the time being.

As described above, in the vehicle display device, vehicle, vehicle display system, vehicle display method and program of the present exemplary embodiment, when a specific event occurs, the hazard map image 26 of a predetermined geographical region can be displayed on the display 22. If the hazard map image 26 were to be displayed on the display 22 frequently regardless of the occurrence of a specific event, it would be easy for the vehicle occupant who is viewing the display 22 to become annoyed. Therefore, it would be easy for the attention of the vehicle occupant when perceiving the hazard map image 26 to decrease. In contrast, in a case in which the hazard map image 26 is displayed on the display 22 when a specific event occurs as in the present exemplary embodiment, it is difficult for the vehicle occupant who is viewing the display 22 to become annoyed. Therefore, there is a strong possibility that the vehicle occupant will perceive the information of the hazard map image 26 with a high level of attention.

Moreover, in the present exemplary embodiment, when a specific event occurs, the notification image 27A, 27B, 27C, which urge the vehicle occupant to execute a touch-operation with respect to the operation screen (the Yes button image 28A) displayed on the display 22 (the touch panel) provided at the vehicle 20, is displayed on the display 22. When a vehicle occupant executes a touch-operation with respect to the operation screen (the Yes button image 28A) displayed on the display 22 (the touch panel), the hazard map image 26 is displayed on the display 22. In this way, in a case in which the hazard map image 26 is displayed on the display 22 when a vehicle occupant executes a touch-operation by their own intent, it is difficult for the vehicle occupant who is viewing the display 22 to become annoyed, as compared with a case in which the hazard map image 26 is displayed on the display 22 regardless of the intent of the vehicle occupant.

Moreover, in the present exemplary embodiment, when a touch-operation with respect to the display 22 (touch panel) is executed, the hazard map image 26, which relates to the displayed region that is the geographical region selected from among plural geographical regions, is displayed on the display 22. In this way, in a case in which the hazard map image 26 which relates to the displayed region that the vehicle occupant selects by their own intent, is displayed on the display 22, it is difficult for the vehicle occupant who is viewing the display 22 to become annoyed, as compared with a case in which the hazard map image, which relates to a geographical region selected regardless of the intent of the vehicle occupant, is displayed on the display 22.

Moreover, in the present exemplary embodiment, a specific event occurs when Disaster Prevention Day or the day of a disaster preparedness event, which are predetermined days, arrives, or when the date of the occurrence of a first category of great disaster or the date of the occurrence of a second category of great disaster arrives. In this way, in a case in which the hazard map image 26 is displayed on the display 22 on a predetermined day, there is a low possibility that the vehicle occupant who is viewing the display 22 will be annoyed.

Here, a comparative example, in which a specific event occurs when a predetermined point in time of a predetermined day arrives, is assumed. In this comparative example, when a vehicle occupant uses the vehicle 20 during a time span that is different than the predetermined point in time of the predetermined day (i.e., when the vehicle occupant does not use the vehicle 20 at the predetermined point in time in time), the vehicle occupant cannot see the hazard map image 26. In contrast, as in the present exemplary embodiment, in a case in which a specific event occurs when the IG-SW 24 is set in an on state in any time span of the predetermined day, the vehicle occupant can see the hazard map image 26 if the vehicle occupant sets the IG-SW 24 in an on state in any time span of the predetermined day.

Moreover, in the present exemplary embodiment, data relating to the hazard map is recorded in the ROM 30B or the storage 30D of the external server 30. Therefore, there is no need for the vehicle 20 to be equipped with a recording device that records information relating to the hazard map.

The vehicle display device, vehicle, vehicle display system, vehicle display method and program relating to an exemplary embodiment have been described above. However, the designs of the vehicle display device, the vehicle, the vehicle display system, the vehicle display method and the program can be changed appropriately within a scope that does not depart from the gist of the present disclosure.

For example, at the time when the vehicle 20 arrives at the destination of the traveling route, a specific event may occur regardless of the establishment of conditions 1 to 3. In a case in which the hazard map image is displayed on the display 22 when the vehicle 20 arrives at the destination, the possibility that the vehicle occupant who is viewing the display 22 will be annoyed is low as compared with a case in which the hazard map image is displayed on the display 22 during traveling of the vehicle 20.

For example, at the time when a specific event occurs, the hazard map image may be displayed on the display 22 regardless of the intent of the vehicle occupant, due to the ECU 21 controlling the display 22.

Moreover, when a specific event occurs when the display 22 is in an off state, the display 22 may be switched to the on state due to the ECU 21 controlling the display 22, regardless of the intent of the vehicle occupant. In this case, the ECU 21 may display the notification image 27A, 27B, 27C, the Yes button image 28A and the No button image 28B on the display 22, or a hazard map image of a predetermined geographical region may be displayed regardless of the intent of the vehicle occupant.

For example, when a specific event occurs, the speaker (notification device) 23 may output the information shown by the notification image 27A, 27B, 27C. Further, when a specific event occurs, a display (notification device) or a speaker (notification device) of a portable terminal (e.g., a smartphone) that can communicate wirelessly with the vehicle 20 may output the information shown by the notification image 27A, 27B, 27C. Further, when a specific event occurs, a hazard map image of a predetermined geographical region may be displayed on the display of the portable terminal, regardless of the intent of the vehicle occupant.

The vehicle display system may be configured such that, in the state in which the hazard map image 26 is displayed on the display 22, in a case in which the vehicle occupant carries out a predetermined operation with respect to an input device (e.g., the aforementioned touch panel) that is provided at the vehicle, the hazard map image 26 is continued to be displayed on the display 22 even after the aforementioned display time elapses.

Moreover, the vehicle 20 may be equipped with a voice recognition device (first operation device, second operation device). In this case, the vehicle occupant gives, by voice, an instruction as to whether or not to display the hazard map image on the display 22, and an instruction relating to which geographical region is to be selected as the displayed region. The voice recognition device recognizes this voice instruction, and the recognized contents of the instruction are transmitted from the voice recognition device to the ECU 21.

For example, a hazard map image, which shows only the peripheral region of part of the traveling route set by the navigation system, and a hazard map image, which shows only the peripheral region of the destination, may be displayed on the display 22. For example, a hazard map image (the first warning image 26A), which shows only the peripheral region of part of the traveling route Rt displayed in FIG. 9, FIG. 12 and FIG. 13, may be displayed on the display 22.

The ECU 21 of the vehicle 20 may have the functions of the external server 30. In this case, the data relating to the hazard map of the entire country in which the vehicle 20 is located is recorded in the ROM 21B or the storage 21D of the vehicle 20. In this case, the vehicle display system is configured by the vehicle 20.

Data relating to the hazard map of only a part of the country in which the vehicle 20 is located may be recorded in a recording device of at least one of the vehicle 20 and the external server 30. Further, data relating to the hazard map of country other than the country in which the vehicle 20 is located may be recorded in a recording device of at least one of the vehicle 20 and the external server 30.

The number of select button images included in the region select button image 29 may be a number other than 7.

The vehicle display system 10 may be configured such that a vehicle occupant can simultaneously touch-operate plural select button images included in the region select button image 29. In this case, map images of the plural geographical regions that are selected and hazard map images corresponding to the respective geographical regions are displayed on the display 22.

Instead of the GPS receiver 25, the vehicle 20 may have a receiver that can receive information from satellites of a global navigation satellite system other than GPS (e.g., Galileo).

The ECU 21 may read-in map data from a web server, and display map images that are based on the map data on the display 22.

What is claimed is:

1. A vehicle display device comprising:
a memory;
a display installed at a vehicle; and
a processor coupled to the memory and controlling the display, wherein the processor is configured to:
when a specific event occurs, set the display to a state of being able to display a hazard map image showing a hazard map of a predetermined geographical region.

2. The vehicle display device of claim 1, further including a receiver that receives information relating to the hazard map image by wireless communication from an external communication device.

3. The vehicle display device of claim 1, wherein the hazard map image is a hazard map image of a geographical region that includes a current position of the vehicle.

4. The vehicle display device of claim 1, further including a navigation system that sets a traveling route to a destination, wherein:
the display displays a map image that includes the destination and the traveling route, and
the specific event occurs when the vehicle arrives at the destination.

5. The vehicle display device of claim 1, wherein the processor is configured to, in a case in which a select operation, which selects at least one displayed region from among a plurality of geographical regions, is executed with respect to a first operation device provided at the vehicle, cause the display to display the hazard map image relating to the displayed region.

6. The vehicle display device of claim 1, wherein the processor is configured to:
when the specific event occurs, cause a notification device to give notice of information urging a vehicle occupant of the vehicle to execute a display operation with respect to a second operation device provided at the vehicle, and
in response to execution of the display operation with respect to the second operation device, cause the display to display the hazard map image.

7. The vehicle display device of claim 1, wherein the specific event occurs when a predetermined day arrives.

8. A vehicle comprising the vehicle display device of claim 1.

9. A vehicle display system comprising:
the vehicle of claim 8; and
an external communication device that wirelessly transmits information relating to the hazard map image to a receiver provided at the vehicle.

10. A vehicle display method wherein a processor is configured to, when a specific event occurs, set a display installed in a vehicle in a state of being able to display a hazard map image showing a hazard map of a predetermined geographical region.

11. A non-transitory computer-readable medium on which is recorded a program that causes a processor to execute processing of, when a specific event occurs, setting a display installed in a vehicle in a state of being able to display a hazard map image showing a hazard map of a predetermined geographical region.
